(19) United States
(12) Patent Application Publication
(10) Pub. No.: US 2004/0117823 A1
(43) Pub. Date: Jun. 17, 2004

(54) Method and system for media exchange network functionality synchronized with media broadcasting

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,081

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/445,936, filed on Feb. 7, 2003.

(51) Int. Cl. G06F 13/00

(52) U.S. Cl. 725/39

(57) ABSTRACT

Certain embodiments of the invention may be found in a method and system for providing access to information related to a broadcast television program. Aspects of the method may comprise the steps of delivering the broadcast television program for display on a television screen within a home and receiving an input such as a code from a user that selects a function which corresponds to at least a portion of the broadcast television program during delivery. In response to the received input, the function may be performed at least in part outside the home. An association may be created between the function and at least a portion of the broadcast television program. A user may be notified of one or more functions that may be associated with the broadcast television program.

### CROSS-REFERENCE TO RELATED APPLICATIONS/INCORPORATION BY REFERENCE

This application makes reference to, claims priority to, and claims the benefit of:

U.S. Provisional Application Serial No. 60/432,472 (Attorney Docket No. 14185US01 01001 P-BP-2800) filed Dec. 11, 2002;

U.S. Provisional Application Serial No. 60/443,894 (Attorney Docket No. 14274US01 01 002P-BP-2801) filed Jan. 30, 2003;

U.S. Provisional Application Serial No. 60/457,179 (Attorney Docket No. 14825US01 01015P-BP-2831) filed Mar. 25, 2003; and

U.S. Provisional Application Serial No. 60/445,936 (Attorney Docket No. 14306US01 01013P-BP-2814) filed Feb. 7, 2003.

This application also makes reference to:

U.S. application Ser. No. ______ (Attorney Docket No. 14185US02 01001P-BP-2800) filed Sep. 8, 2003;

U.S. application Ser. No. (Attorney Docket No. 14274US02 01002P-BP-2801) filed Sep. 11, 2003; and

U.S. application Ser. No. (Attorney Docket No. 14307US02 01014P-BP-2815) filed Sep. 30, 2003;

All of the above stated applications are incorporated herein by reference in their entirety.

### FIELD OF THE INVENTION

Certain embodiments of the invention relate to media functionality. In particular, certain embodiments of the invention relate to a method and system for providing functionality to a user of a media exchange network that is synchronized to media broadcasting.

### BACKGROUND OF THE INVENTION

In current systems, broadcasters generally provide basic television programming media to users. This may include point-to-point communication or point-to-multipoint communication such as cable broadcasting and satellite broadcasting. In this regard, all functional aspects of the broadcasting are fully controlled by the broadcasters and such control occurs independent of the user. For example, a broadcaster of a live broadcast may typically control the program views that are broadcast at any given time. A user or subscriber located at an access point such as a home simply views the program content that may be broadcast to the user or subscriber by the broadcaster. Accordingly, in this manner the program views are independently broadcasted, received and viewed by the user or subscriber.

Televisions (TVs) and set-top boxes may provide certain functionality to a user that may be independent of the broadcasters and the broadcast media being provided. For example, a user of a television may control or set the volume of a particular broadcast channel to a particular level by increasing or decreasing a volume associated with the broadcast. However, when the user selects another broadcast channel, the volume associated with the received media will differ from the volume that was previously set by the user. In this regard, since the volume control functionality is internal to the television and is not a part of the actual media that is being broadcasted, the volume setting established by the user is independent of the received broadcast media.

Furthermore, a user may record a broadcast media and then later playback the broadcast media and utilize certain functions such as fast forward, slow forward, rewind, slow rewind, fast rewind, for example. These functions are independent of the broadcaster and the broadcast media and are only a function of, for example, a television, a VCR or a set-top box.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for providing access to information related to a broadcast television program. Aspects of the method may include the steps of delivering the broadcast television program for display on a television screen within a home and receiving an input such as a code from a user that selects a function which corresponds to at least a portion of the broadcast television program during delivery. In response to the received input, the function may be performed at least in part outside the home. An association may be created between the function and at least a portion of the broadcast television program.

A user may be notified of one or more functions that may correspond to at least a portion of the broadcast television program. An indication of the function may be broadcasted along with the broadcast television program. The input may be generated by a remote control, a keyboard, a scanning device and/or an audio processing device. Supplemental information related to the broadcast television program may be generated in response to the received input and presented to the user. The supplemental information may be presented concurrently with delivery of the broadcast television program. Information related with the performance of the function may be presented to the user.

Another embodiment of the invention may provide a machine-readable storage, having stored thereon, a computer program having at least one code section for providing access to information related to a broadcast program. The at least one code section may be executable by a machine, thereby causing the machine to perform the steps as described above in the method for providing access to information related to a broadcast program.

Aspects of the system may include at least one processor adapted to receive delivered broadcast television program for display on a television screen within a home. The processor may be adapted to receive an input such as a code from a user that selects a function which is associated with and corresponds to at least a portion of the broadcast television program during the delivering. In response to the received input, the function may be performed at least in part outside the home by the at least one processor. The processor may be a media processing system processor, a media management system processor, a computer processor, a media exchange software processor, a media peripheral processor or a combination thereof.

The processor may be adapted to notify a user of one or more functions that may correspond to at least a portion of the broadcast television program. Accordingly, an indication of the function may be broadcasted along with the broadcast television program and received by the processor. The input may be generated by a remote control, a keyboard, a scanning device and/or an audio processing device. Supplemental information related to the broadcast television program may be generated in response to the input received by the processor. Accordingly, the process may be adapted to cause the supplemental information to be presented to the user. In an aspect of the invention, the processor may present the supplemental information concurrently with delivery of the broadcast television program. Information related with the performance of the function may be presented by the processor to the user.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an embodiment of a media exchange network providing functionality synchronized with media broadcasting, in accordance with an embodiment of the present invention.

FIG. 2 is a flowchart illustrating an embodiment of a method to provide functionality synchronized with media broadcasting in the media exchange network of FIG. 1, in accordance with an embodiment of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the invention may be found in a method and system for providing access to information related to a broadcast television program. Aspects of the method may include delivering the broadcast television program for display on a television screen within a home. An input may be received from a user that selects a function which corresponds to and is associated with at least a portion of the broadcast television program during delivery. The input may be a code that may be generated by a remote control, a keyboard, a scanning device and/or an audio processing device. Notwithstanding, in response to the received input, the function may be performed at least in part outside the home. Information related with the performance of the function may also be presented to the user. Users may be notified of one or more functions that may be associated with at least a portion of a broadcast television program. In an aspect of the invention, an indication of associated functions may be broadcasted along with the broadcast television program. Supplemental information related to the broadcast television program may also be generated and presented to the user in response to the received input. The supplemental information may be presented concurrently with delivery of the broadcast television program.

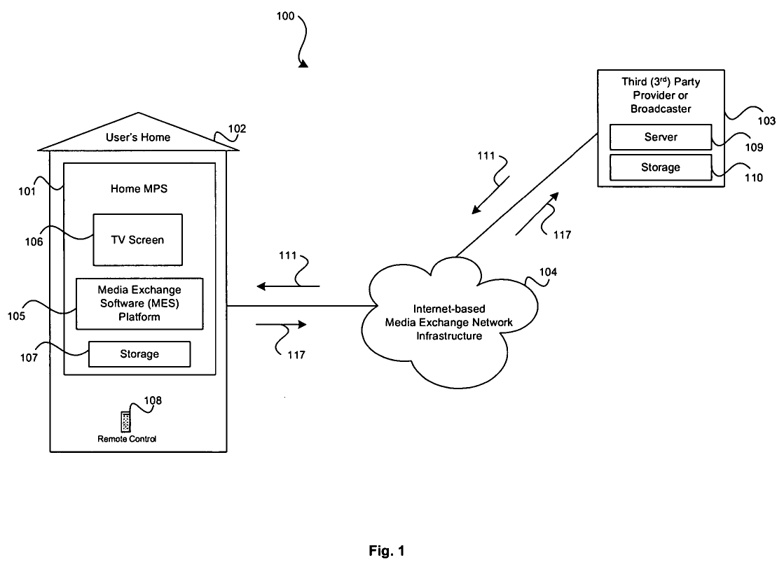

FIG. 1 is a diagram illustrating an embodiment of a media exchange network 100 providing functionality synchronized with media broadcasting, in accordance with an embodiment of the present invention. Referring to FIG. 1, the media exchange network 100 may include a user location which may be a user's home 102, an Internet-based media exchange network infrastructure 104 and a third (3^{rd}) party media provider or broadcaster 103.

The user location or user's home 102 may include a home media processing system (MPS) 101 and a remote control 108. The Internet-based media exchange network infrastructure 104 provides connectivity between the media processing system 101 and the third (3^{rd}) party broadcaster 103. In the exemplary embodiment of FIG. 1, since the media processing system 101 is located at the user's home, it may be referred to as a home media processing system 101.

The media processing system 101 may include a media exchange software (MES) platform 105, a TV screen 106 and a storage block 107. The media exchange software platform 105 provides certain functionality within the media processing system 101, which may include, but is not limited to, the ability to receive and process broadcast media content and associated synchronized functionality from the media exchange network 100. The media exchange software platform 105 may also provide a user with the capability to select a media exchange function from the provided synchronized functionality and to push or otherwise cause the communication of media associated with the selection on the media exchange network 100 via the Internet-based media exchange network infrastructure 104.

The media exchange software platform 105 may also provide a user of the media processing system 101 with the capability to control interaction of the synchronized functionality of broadcasted media using, for example, the remote control 108. In this regard, the remote control 108 may be adapted to receive a user input and control the synchronized functionality of the media processing system 101. The remote control 108 may communicate in a wireless manner with the MPS 101 via infrared or RF signals, in accordance with various embodiments of the invention.

Although the remote control 108 may be utilized to control at least some of the synchronized functionality of the media processing system 101, the invention is not so limited. Accordingly, the user may utilize other devices that may function as I/O devices and/or navigational tools to control the synchronized functionality of the media processing system 101. For example, a mouse, a touch-screen TV display, and/or a keyboard may be utilized to control the synchronized functionality of the media processing system 101. In accordance with another aspect of the invention, a special code reading device may be utilized to scan, read and/or interpret various synchronized functionality codes that may be displayed on the TV screen 106. The special code reading device may also have the capability to scan synchronized functionality that may be found in print media including, but not limited to, magazines, newspapers, books and charts.

In accordance with various embodiments of the invention, a media processing system may also include a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any of the personal computers may indirectly access and/or control any media peripheral device in instances where the personal computer may include a media management system. Such access and/or control may be accomplished through various communication pathways via the MPS or outside of the media processing system. A media processing system may also have the capability to automatically access and control any media peripheral device without user interaction and/or with user interaction. A personal computer (PC) may include media exchange software running on or being executed by the personal computer and may be referred to as a media processing system. The media processing system may also include a speech recognition engine that may be adapted to receive input speech and utilize the input speech control various functions of the media processing system. Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

The communication infrastructure 105 may include cable infrastructure, xDSL infrastructure, satellite network infrastructure, Internet infrastructure, intranet infrastructure or other similar access and/or transport infrastructure. In this regard, the Internet-based media exchange network infrastructure 104 may provide access and/or transport functionality that may facilitate the exchange of media between, for example, the user's home 102 and the third (3^{rd}) party broadcaster or provider 103. The intranet infrastructure which may be part of the Internet-based media exchange network infrastructure may also be adapted to providing wide area network (WAN) capability.

The third (3^{rd}) party media provider or broadcaster 103 may supply third (3^{rd}) party media content to user locations such as the user's home 102 via the Internet-based media exchange network infrastructure. The supplied third (3^{rd}) party media content may include media. The third (3^{rd}) party media provider or broadcaster 103 may include a server 109 and a storage block 110.

The server 109 may be, for example, a file-based server and may be implemented as part of or an adjunct to a personal computer (PC) and/or a mainframe computer system. Notwithstanding, the server 109 may have the capability to push broadcast media content that is stored in the storage block 110 to the media processing system 101 via the Internet-based media exchange network infrastructure 104. In accordance with an aspect of the invention, the server 109 may also be configured to provide synchronized functionality 111 to user's of the media exchange network 100.

The storage block 110 may be utilized to store media content provided by the (3^{rd}) party media provider or broadcaster 103. The storage block 1 10 may include, but is not limited to, a database, a CD tower, a jukebox, a magnetic disk, an optical disk, a magneto-optical disk, a solid state memory device, a tape device, a media peripheral, a server, a media processing system and a computer having various memory and/or storage devices.

The media processing system 101 may have the capability to receive the broadcast media and synchronized functionality 111 and select a particular media exchange function 117, in accordance with various embodiments of the present invention. The TV screen 106 of the media processing system 101 may provide a user with the capability to view broadcast media content and synchronized functionality 111. Accordingly, a notification associated with the synchronized functionality options from the third (3^{rd}) party broadcaster 103 may be displayed on the TV screen 106 of media processing system 101. The notification may be automatically displayed or it may be displayed based on user interaction. For example, the user interaction may include the pushing of a button on the remote control 108 by a user of the media processing system 101. In this regard, the user may choose when to view the notification and may even decide what types of notification should be received and when they should be received.

In accordance with an embodiment of the present invention, the synchronized functionality may be provided by the 3^{rd} party broadcaster 103 along with a media broadcast. The synchronized functionality may include at least one media exchange function that may be selectable by a user. In other words, while a user's media processing system may be displaying an audio, video and/or data representation of a real-time media broadcast, a media exchange function related to the media broadcast may be made available to the user, either automatically or through user interaction. In any case, upon selection by a user, media content may be communicated from the third (3^{rd}) party media provider or broadcaster to the user. In this regard, the media content associated with the selected media exchange function may be transferred from the third (3^{rd}) party media provider or broadcaster to the user subsequent to the user selection.

The synchronized functionality may provide the user or a subscriber with the capability to request supplemental information related to the media content associated with a particular media broadcast. Accordingly, the user may have the capability to request that the media broadcast or portions thereof be delivered in a different language or in a different view. Hence, a user or subscriber may request that at least a portion of the media broadcast be presented in English, Spanish, and/or French, for example. In other exemplary aspects of the invention, a user or subscriber may have the capability to engage in sales interactions and request a related personal interview, for example.

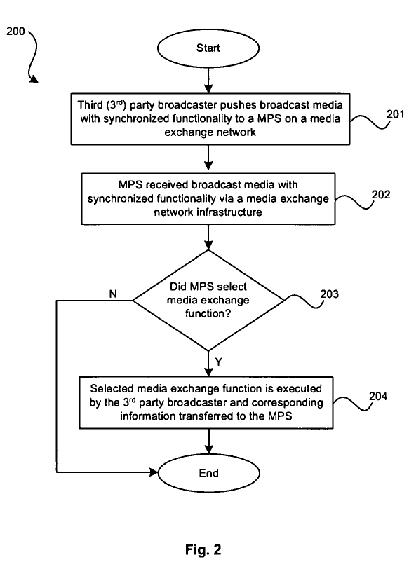

FIG. 2 is a flowchart illustrating an embodiment of a method 200 to provide functionality synchronized with media broadcasting in the media exchange network 100 of FIG. 1, in accordance with an embodiment of the present invention. Referring to FIG. 2, in step 201, a third (3^{rd}) party broadcaster pushes broadcast media and synchronized functionality to a media processing system on a media exchange network. In step 202, the media processing system receives the broadcast media and synchronized functionality via an Internet-based media exchange network infrastructure. In step 203, a determination is made as to whether the media processing system selected a media exchange function from the synchronized functionality. If the media processing system does select a media exchange function, then in step 204, the selected media exchange function is executed by the third (3^{rd}) party broadcaster and corresponding information transferred to the media processing system.

In an illustrative embodiment of the invention, a user of the media processing system 101 may be watching a football game on the TV screen 106 of the media processing system 101. The media content for the football game may be provided by the third (3^{rd}) party media provider or broadcaster 103 along with synchronized functionality. The user of the media processing system 101 may have a desire to see an alternate view of the football game, which may differ at least in part from a current view being provided by the third (3^{rd}) party broadcaster 103 is currently providing. As a result, the user may utilize the remote control 108 to cause the media processing system 101 to display, for example, a menu or window on the TV screen 106. The menu may list various media exchange functions that may be provided by the third (3^{rd}) party broadcaster. Accordingly, one of the media exchange functions 117 may allow the user to select the desired alternate view. The user may then select the displayed desired function. Upon selection of the desired function by the user, a representation of the selection may be sent over the media exchange network 100 to the third (3^{rd}) party broadcaster 103. In response to receiving the selection, the third (3^{rd}) party broadcaster 103 may push or otherwise cause the desired alternate view of the football game to be communicated to the user of MPS 101. The alternate view may then be displayed on the TV screen 106 of the media processing system 101.

In another exemplary embodiment of the invention, a user of the media processing system 101 may have noticed that one of the media exchange functions available from the broadcaster is an interview with the quarterback of one of the teams participating in the football game. The user may select the interview function 117 and, as a result, the third (3^{rd}) party broadcaster may push or cause media content associated with the interview to be communicated to the media processing system 101. The media content associated with the interview may be displayed, for example, in a picture-in-picture (PIP) window of the TV screen 106 while the user continues to watch the football game on the rest of the TV screen 106. The picture-in-picture window may be moveable and in this regard, the remote control 108, for example, may be utilized to move the picture-in-picture window across the TV screen 106 for a more flexible viewing experience.

In another aspect of the invention, the third party media provider or broadcaster 103 may provide supplemental information related to media content distributed to the media processing system 101. The supplemental information may include, but is not limited to, an author's name, an actor's name, a history associated with the media broadcast, and a version of the media broadcast. In this regard, a user of the media processing system 101 may utilize the remote control 108 to cause the media processing system 101 to display, for example, a menu or window on the TV screen 106. The menu may include a list of various media exchange functions associated with the supplemental information that may be provided by the third (3^{rd}) party broadcaster 103. The user may utilize the remote control 108 or other navigation device or tool to select a desired supplemental information function. Upon selection of the desired function by the user, a representation of the selection may be sent over the media exchange network 100 to the third (3^{rd}) party broadcaster 103. In response to receiving the selection, the third (3^{rd}) party broadcaster 103 may push or otherwise cause the desired supplemental information to be communicated to the user of media processing system 101. The supplemental information may then be displayed on the TV screen 106 of the media processing system 101.

As part of the supplemental information, a third (3^{rd}) party broadcaster 103 may also provide supplemental information associated with a movie broadcast that may allow a user to purchase clothing of a kind and/or similar to that which may be worn and/or promoted by certain actors in the movie broadcast. This is an example of sales interaction that may take place on the media exchange network in accordance with an embodiment of the present invention. U.S. application Ser. No. ______ (Attorney Docket No. 14305US02) discloses a method and system for media exchange network with service a broadcast user functionality, which provides, among other things, information related to a broadcast television program and is incorporated herein by reference in its entirety.

In another exemplary embodiment of the invention, a user may be viewing movie in the English language on the media processing system 101 and may have a desire to switch the language to an alternate language. For example, a friend who may be visiting at the user's home 102 may have a desire to view the movie in French rather than in its current English format. The user, who may also be acquainted with the French language, may select, for example, a “change language” function 117 provided by the third (3^{rd}) party broadcaster 103 of the movie. The “change language” function may provide a French language option and that French language selection may be transferred from the MPS 101 to the third (3^{rd}) party media provider or broadcaster. Upon receiving the French change language selection, the third (3^{rd}) party media provider or broadcaster may then push or other cause French language audio, video and/or text to be communicated to the media processing system 101, where it may be viewed on the TV screen 106. The language associated with the movie content may therefore be changed in accordance with an embodiment of the present invention.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

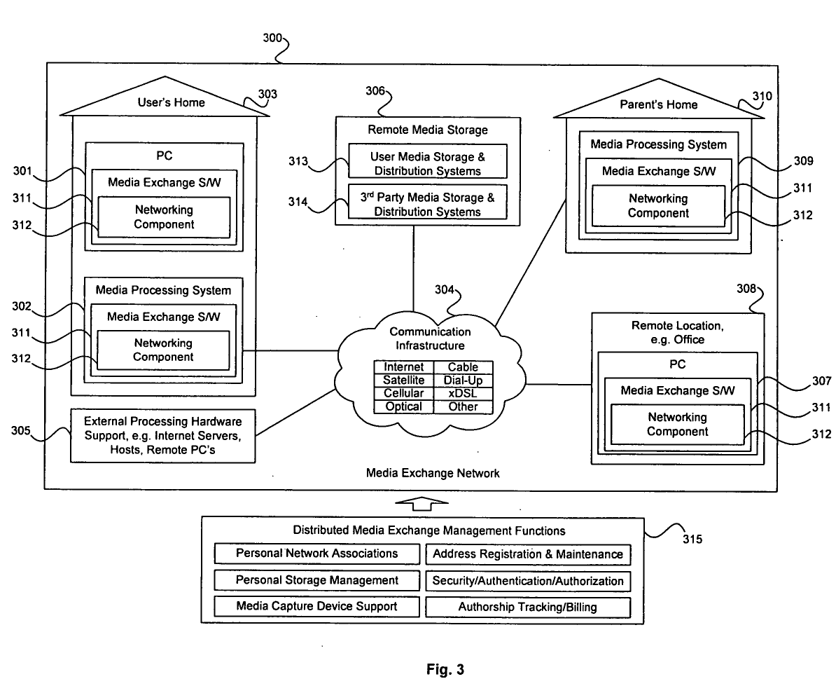

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

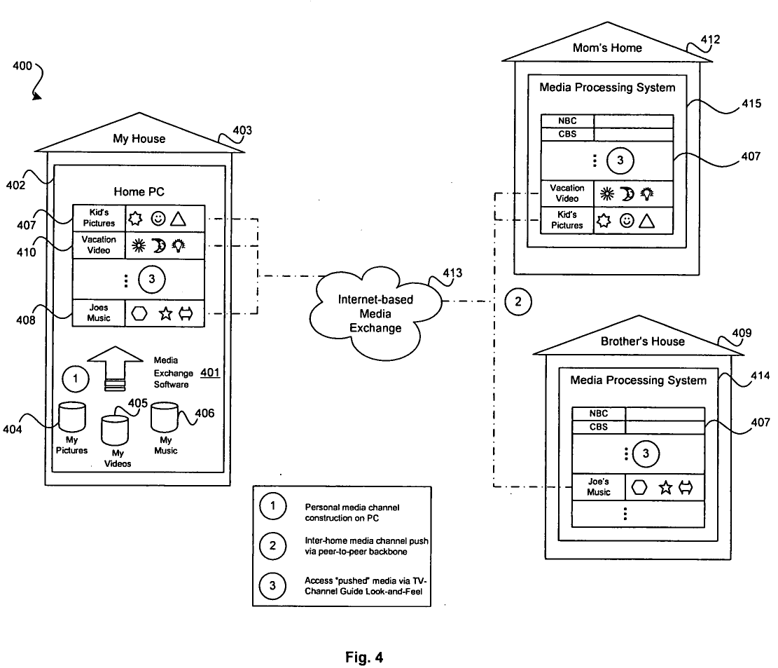

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

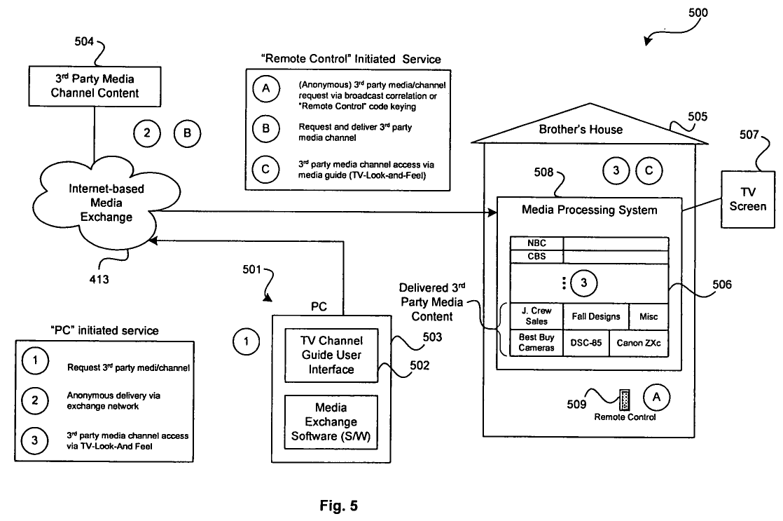

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

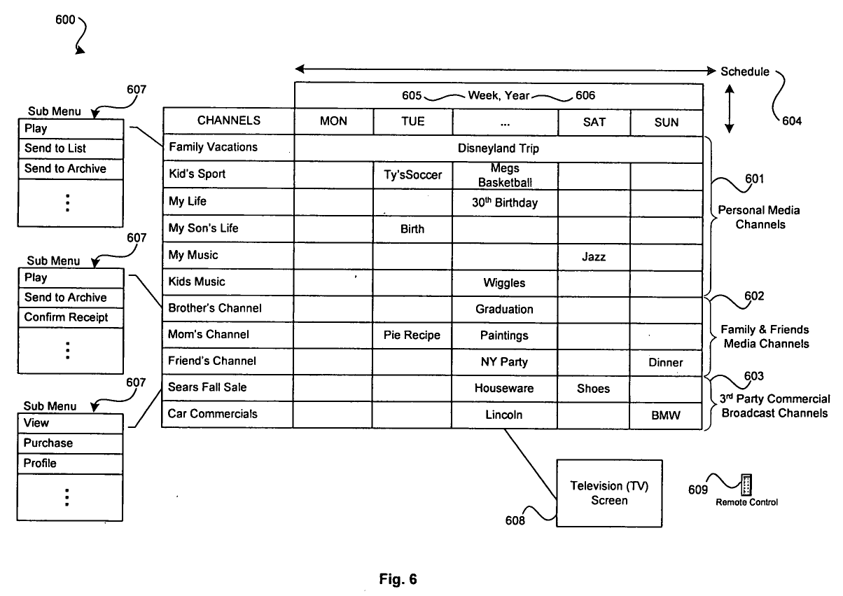

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

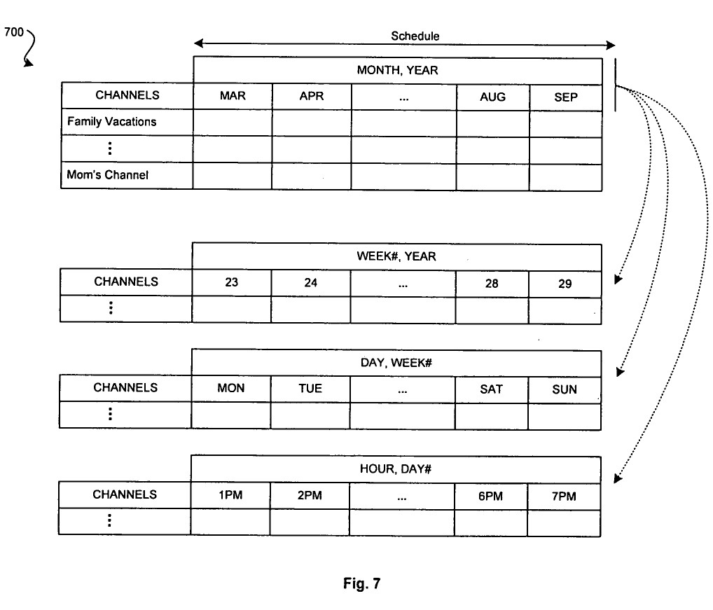

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

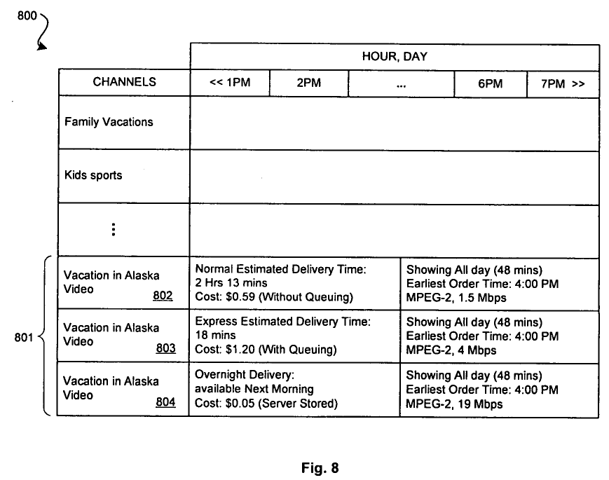

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

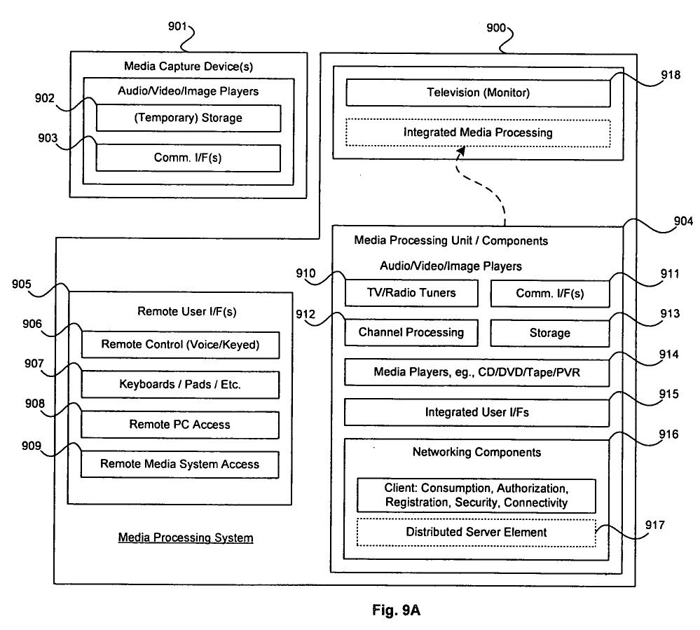

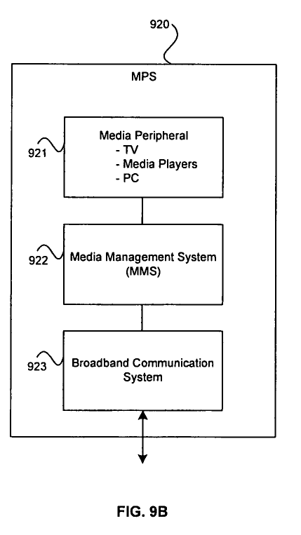

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

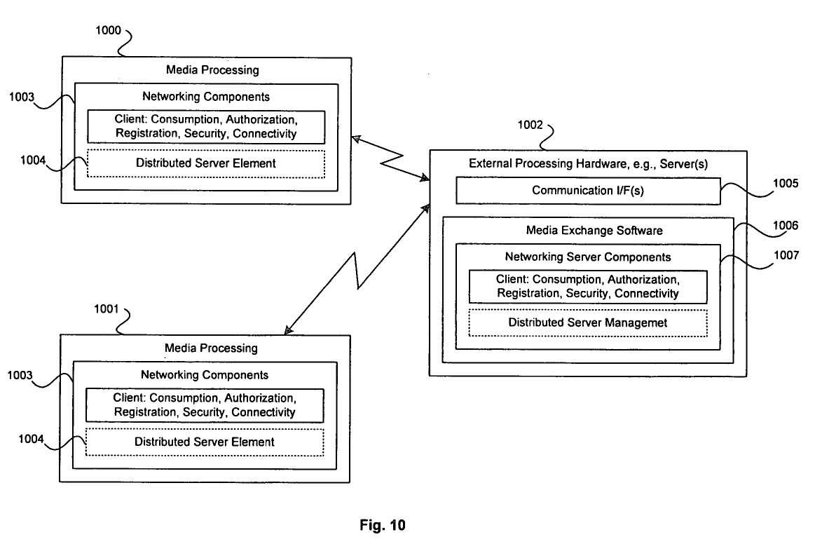

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

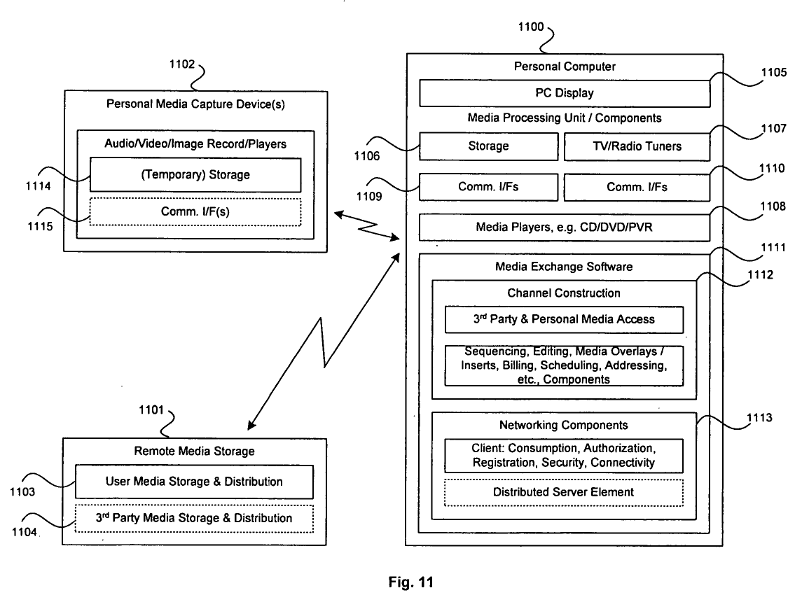

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Another embodiment of the invention may comprise a method and a system for providing media content. Certain aspects of the method may comprise receiving an input from a user that selects at least one media program function or function that is associated with a media program generated by a third (3^{rd}) party media provider or provider such as a broadcaster. The received input may be communicated from the user to the provider and in response, media content corresponding to the selected function along with the media program may be received from at least the provider. At least a portion of the media content received from the provider may be presented to the user via, for example, a media processing system and displayed on a television display coupled to the media processing system. The media content provided by the third (3^{rd}) party media provider may include audio, video and text, for example. The media program may be a television broadcast program.

In accordance with an aspect of the invention, a user may be notified whenever a function associated with a media program is available. At least one functionality code corresponding to the media program function may be received. The received functionality code may be generated from, for example, a remote control device, a keyboard, a scanning device and/or an audio processing device. In response to the received input, supplemental information related to the media program may also be received and presented to the user based on the received user input.

Certain aspects of the system for providing media content may include at least one processor that may receive an input from a user that selects at least one media program function associated with a media program generated by a third (3^{rd}) party media provider 103 or provider 103. The user may be situated at the user location 102. The processor may be a media processing system 101. However, the invention may be so limited and processor may include a media management system processor, a computer processor, a media exchange software processor, a media peripheral processor or a combination thereof. Notwithstanding, the media processing system 101 may communicate the received input from the user to the provider 103. In response to the received input, media content corresponding to the selected media program function along with the media program may be received by the media processing system 101 from the provider 103. The media content may include audio, video, text or the like, which may be provided by provider 103. Notwithstanding, at least a portion of the received media content corresponding to the selected media program function may be presented to the user by the media processing system 101. In this regard, at least a portion of the received media content corresponding to the selected media program function may be transferred to the media processing system 101. The media processing system 101 may then cause at least a portion of the received media content to be displayed on a television screen 106 coupled to the media processing system 101.

The media processing system 101 may be adapted to notify the user whenever a media function associated with a media program becomes available. At least one functionality code that may correspond with the media program function may be received and processed by the media processing system 101. In an aspect of the invention, the received functionality code may be generated by at least one of a remote control device, a keyboard, a scanning device and an audio processing device, for example. Notwithstanding, media processing system 101 may be configured to receive supplemental information related to the media program in response to the received input. Accordingly, the received supplemental information may be presented to the user by the media processing system 101 based on the input received from the user.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing access to information related to a broadcast television program, the method comprising:
delivering the broadcast television program for display on a television screen within a home;
receiving an input from a user that selects a function which corresponds to at least a portion of the broadcast television program during said delivering; and
in response to said received input, performing said function at least in part outside said home.

2. The method according to claim 1, further comprising associating said function with the broadcast television program.

3. The method according to claim 1, further comprising notifying said user of said function corresponding to said at least a portion of the broadcast television program.

4. The method according to claim 1, further comprising broadcasting an indication of said function along with the broadcast television program.

5. The method according to claim 1, wherein said input is a code representative of said function.

6. The method according to claim 1, wherein said input is generated from at least one of a remote control, a keyboard, a scanning device and an audio processing device.

7. The method according to claim 1, further comprising generating supplemental information related to the broadcast television program in response to said received input.

8. The method according to claim 7, further comprising presenting said supplemental information to said user.

9. The method according to claim 7, further comprising presenting said supplemental information to said user concurrently with said delivering of the broadcast television program.

10. The method according to claim 1, further comprising displaying information related to said performance of said function.

11. A machine-readable storage having stored thereon, a computer program having at least one code section for providing access to information related to a broadcast television program, the at least one code section being executable by a machine for causing the machine to perform steps comprising:
delivering the broadcast television program for display on a television screen within a home;
receiving an input from a user that selects a function which corresponds to at least a portion of the broadcast television program during said delivering; and
in response to said received input, performing said function at least in part outside said home.

12. The machine-readable storage according to claim 11, further comprising code for associating said function with the broadcast television program.

13. The machine-readable storage according to claim 11, further comprising code for notifying said user of said function corresponding to said at least a portion of the broadcast television program.

14. The machine-readable storage according to claim 11, further comprising code for broadcasting an indication of said function along with the broadcast television program.

15. The machine-readable storage according to claim 11, wherein said input is a code representative of said function.

16. The machine-readable storage according to claim 11, wherein said input is generated from at least one of a remote control, a keyboard, a scanning device and an audio processing device.

17. The machine-readable storage according to claim 11, further comprising code for generating supplemental information related to the broadcast television program in response to said received input.

18. The machine-readable storage according to claim 17, further comprising code for presenting said supplemental information to said user.

19. The machine-readable storage according to claim 17, further comprising code for presenting said supplemental information to said user concurrently with said delivering of the broadcast television program.

20. The machine-readable storage according to claim 11, further comprising code that causes information related to said performance of said function to be displayed.

21. A system for providing access to information related to a broadcast television program, the system comprising:
at least one processor that delivers the broadcast television program for display on a television screen within a home;
said at least one processor receives an input from a user that selects a function which corresponds to at least a portion of the broadcast television program during said delivering; and
said at least one processor performs said function at least in part outside said home in response to said received input.

22. The system according to claim 21, wherein said at least one processor associates said function with the broadcast television program.

23. The system according to claim 21, wherein said at least one processor notifies said user of said function corresponding to said at least a portion of the broadcast television program.

24. The system according to claim 21, wherein said at least one processor broadcasts an indication of said function along with the broadcast television program.

25. The system according to claim 21, wherein said input is a code representative of said function.

26. The system according to claim 21, wherein said input is generated from at least one of a remote control, a keyboard, a scanning device and an audio processing device.

27. The system according to claim 21, wherein said at least one processor generating supplemental information related to the broadcast television program in response to said received input.

28. The system according to claim 27, wherein said at least one processor presents said supplemental information to said user.

29. The system according to claim 27, wherein said at least one processor presents said supplemental information to said user concurrently with said delivering of the broadcast television program.

30. The system according to claim 21, wherein said at least one processor displays information related to said performance of said function.

31. The system according to claim 21, wherein said at least one processor is at least one of a media processing system processor, a media management system processor, a computer processor, media exchange software processor and a media peripheral processor.
